(19) United States
(12) Patent Application Publication
(10) Pub. No.: US 2026/0070419 A1
(43) Pub. Date: Mar. 12, 2026

(54) DISPLAY CONTROLLER, METHOD OF CONTROLLING DISPLAY CONTROLLER, AND STORAGE MEDIUM

(71) Applicant: HONDA MOTOR CO., LTD., Tokyo (JP)

(72) Inventor: Takashi Noguchi, Tokyo (JP)

(21) Appl. No.: 19/303,539

(22) Filed: Aug. 19, 2025

(30) Foreign Application Priority Data
Sep. 9, 2024 (JP) 2024-155065

(51) Int. Cl. B60K 35/81; B60K 35/22; B60K 35/29

(52) U.S. Cl. CPC B60K 35/81; B60K 35/22; B60K 35/29; B60K 2360/111; B60K 2360/115; B60K 2360/184; B60K 2360/48; B60K 2360/583; B60K 2360/741

(57) ABSTRACT

A display controller displays content received by a communication device from outside by a plurality of display units, and the display controller includes a notification unit configured to give notification related to the content to be displayed by the display units based on a first communication speed between the communication device and the outside and a second communication speed between the communication device and the outside required for displaying the content.

### INCORPORATION BY REFERENCE

The present application claims priority under 35 U.S.C. § 119 to Japanese Patent Application No. 2024-155065 filed on Sep. 9, 2024. The content of the application is incorporated herein by reference in its entirety.

### BACKGROUND OF THE INVENTION

### Field of the Invention

The present invention relates to a display controller, a method of controlling the display controller, and a storage medium.

### Description of the Related Art

In recent years, an approach of providing access to a sustainable transportation system considering even vulnerable people like aged people, handicapped people and children among traffic participants is gaining momentum. Towards the realization of this transportation system, the focus is on research and development for further improving traffic safety and convenience through development regarding vehicle comfortability.

Conventionally, as technology related to convenience, technology related to content display has been known (for example, see Japanese Patent No. 6571216). Japanese Patent No. 6571216 discloses technology capable of selecting image quality of video images displayed on a portable information terminal based on a communication amount of data transmitted and received by the portable information terminal.

In recent years, technology of displaying content received from outside by a plurality of display units has been examined. However, depending on the content displayed by the plurality of display units, a communication speed required for displaying the content may be different. Therefore, depending on the content displayed by the plurality of display units, there is a risk that the communication speed required for displaying the content may exceed the communication speed in communication with the outside and the content may not be appropriately displayed.

The present invention is implemented in consideration of the circumstances described above, and an object thereof is to enable a user of content to act such that the content is appropriately displayed according to a communication situation related to the content.

### SUMMARY OF THE INVENTION

One aspect of the present invention is a display controller that displays content received by a communication device from outside by a plurality of display units, and the display controller includes a notification unit configured to give notification related to the content to be displayed by the display units based on a first communication speed between the communication device and the outside and a second communication speed between the communication device and the outside required for displaying the content.

According to one aspect of the present invention, a user of content can act such that the content is appropriately displayed according to a communication situation related to the content.

### BRIEF DESCRIPTION OF THE DRAWINGS

FIG. 1 is a diagram illustrating a configuration of a content distribution system;

FIG. 2 is a diagram illustrating a configuration of a display controller;

FIG. 3 is a flowchart illustrating an operation of the display controller;

FIG. 4 is a diagram illustrating an example of a notification screen;

FIG. 5 is a diagram illustrating an example of changeover of content display;

FIG. 6 is a diagram illustrating an example of the notification screen;

FIG. 7 is a flowchart illustrating the operation of the display controller;

FIG. 8 is a diagram illustrating the configuration of the display controller; and

FIG. 9 is a flowchart illustrating the operation of the display controller.

### DETAILED DESCRIPTION OF THE INVENTION

### 1. First Embodiment

First, with reference to the drawings, the first embodiment will be described.

### 1-1. Configuration of Content Distribution System

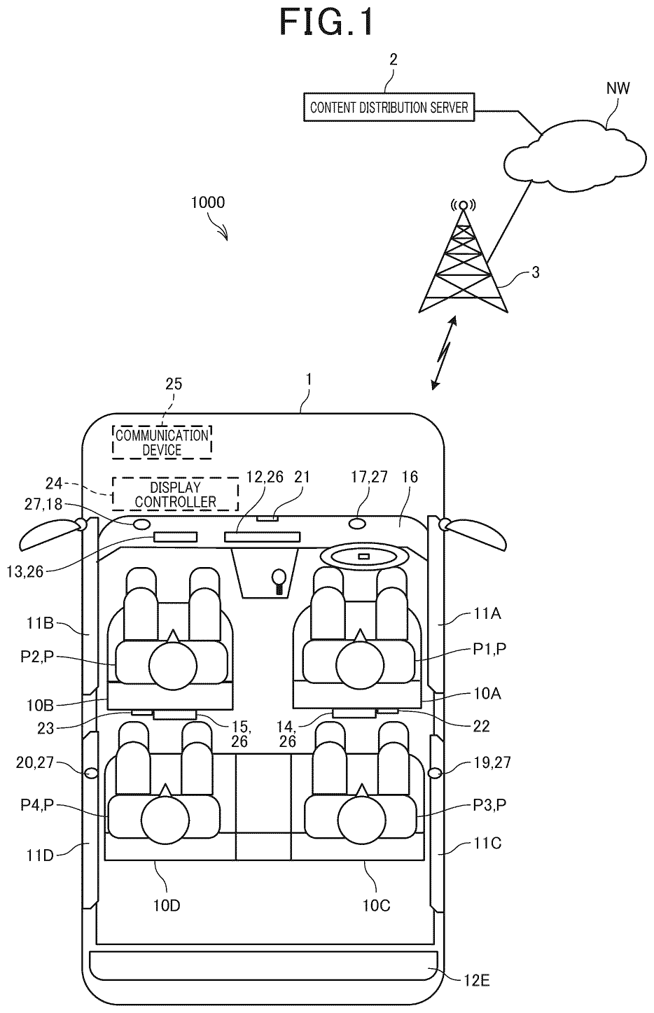

FIG. 1 is a diagram illustrating a configuration of a content distribution system 1000 according to the first embodiment.

The content distribution system 1000 is a system that distributes content to a vehicle 1. Examples of the content distributed by the content distribution system 1000 include movies, still images, and music. The content distributed by the content distribution system 1000 is the content that can be utilized inside the vehicle 1. Note that the content that a passenger P can utilize inside the vehicle 1 is the content that can be output into an interior of the vehicle 1.

The passenger P is an example of a “user”.

As illustrated in FIG. 1, the content distribution system 1000 includes the vehicle 1 and a content distribution server 2.

Before describing the vehicle 1, the content distribution server 2 will be described. The content distribution server 2 is a server device that distributes content. The content distribution server 2 is connected to a network NW, and communicates with the vehicle 1 via a base station 3 connected to the network NW. The network NW is a communication network formed of a public network, an exclusive line, and other communication circuits or the like. The content distribution system 1000 may include the content distribution server 2 for each content distribution source. In addition, the content distribution server 2 may be a server device that integrally distributes the content distributed by a plurality of content distribution sources to the vehicle 1.

The base station 3 is an example of an “outside”.

The vehicle 1 illustrated in FIG. 1 is a four-wheel vehicle. The vehicle 1 includes a driver's seat 10A, a front passenger seat 10B, a rear right seat 10C, and a rear left seat 10D. FIG. 1 illustrates a situation where a passenger P1 who is a driver is seated in the driver's seat in the vehicle 1. In addition, FIG. 1 illustrates a situation where a passenger P2 who is a fellow passenger is seated in the front passenger seat 10B in the vehicle 1. Further, FIG. 1 illustrates a situation where a passenger P3 who is a fellow passenger is seated in the rear right seat 10C in the vehicle 1. Further, FIG. 1 illustrates a situation where a passenger P4 who is a fellow passenger is seated in the rear left seat 10D in the vehicle 1.

The vehicle 1 includes a right front door 11A, a left front door 11B, a right rear door 11C, a left rear door 11D, and a tailgate 11E. Opening the right front door 11A, the left front door 11B, the right rear door 11C, and the left rear door 11D makes it possible to get in and out of an interior space of the vehicle 1. The tailgate 11E opens and closes a trunk of the vehicle 1.

The vehicle 1 includes touch panels 12, 13, 14, and 15. Each of the touch panels 12, 13, 14, and 15 is formed by superimposing or integrating a display panel that displays characters and images and a touch sensor that detects contact to the display panel. The touch panels 12 and 13 are installed on a dashboard 16. The touch panel 13 is installed more on a side of the front passenger seat 10B than the touch panel 12. The touch panel 14 is installed at a position to be visually recognized by the passenger P seated in the rear right seat 10C, on a back surface of the driver's seat 10A for example. The touch panel 15 is installed at a position to be visually recognized by the passenger P seated in the rear left seat 10D, on a back surface of the front passenger seat 10B for example.

The touch panels 12, 13, 14, and 15 are examples of a “display unit”.

Hereinafter, the touch panels 12, 13, 14, and 15 are denoted by a reference numeral “26” and expressed as touch panels 26, when not to be distinguished from each other.

The vehicle 1 includes speakers 17, 18, 19, and 20. The speaker 17 outputs sound to the passenger P seated in the driver's seat 10A. The speaker 18 outputs sound to the passenger P seated in the front passenger seat 10B. The speaker 19 outputs sound to the passenger P seated in the rear right seat 10C. The speaker 20 outputs sound to the passenger P seated in the rear left seat 10D. Note that installation positions of the speakers 17, 18, 19, and 20 are not limited to those in FIG. 1 and may be positions from which sound can be output to the passenger P seated in the corresponding seat.

Hereinafter, the speakers 17, 18, 19, and 20 are denoted by a reference numeral “27” and expressed as speakers 27, when not to be distinguished from each other.

In the interior of the vehicle 1, cameras 21, 22, and 23 that photograph the interior of the vehicle 1 are installed.

A photographing range of the camera 21 is set to a range where it is possible to photograph the passenger P seated in the driver's seat 10A and the passenger P seated in the front passenger seat 10B. More specifically, the photographing range of the camera 21 is set to the range where it is possible to photograph heads (including faces) of the two passengers P.

The camera 22 is installed on the back surface of the driver's seat 10A for example, and photographs the passenger P seated in the rear right seat 10C. A photographing range of the camera 22 is set to a range where it is possible to photograph the passenger P seated in the rear right seat 10C. More specifically, the photographing range of the camera 22 is set to the range where it is possible to photograph the head (including the face) of the passenger P seated in the rear right seat 10C.

The camera 23 is installed on the back surface of the front passenger seat 10B for example, and photographs the passenger P seated in the rear left seat 10D. A photographing range of the camera 23 is set to a range where it is possible to photograph the passenger P seated in the rear left seat 10D. More specifically, the photographing range of the camera 23 is set to the range where it is possible to photograph the head (including the face) of the passenger P seated in the rear left seat 10D.

The vehicle 1 includes a display controller 24. The display controller 24 outputs the content distributed by the content distribution server 2 to the vehicle interior. The display controller 24 displays various kinds of information by the touch panels 12, 13, 14, and 15.

The vehicle 1 includes a communication device 25. The communication device 25 includes hardware according to a predetermined communication standard such as a wireless communication circuit, and communicates with the content distribution server 2 via the base station 3.

### 1-2. Configuration of Display Controller

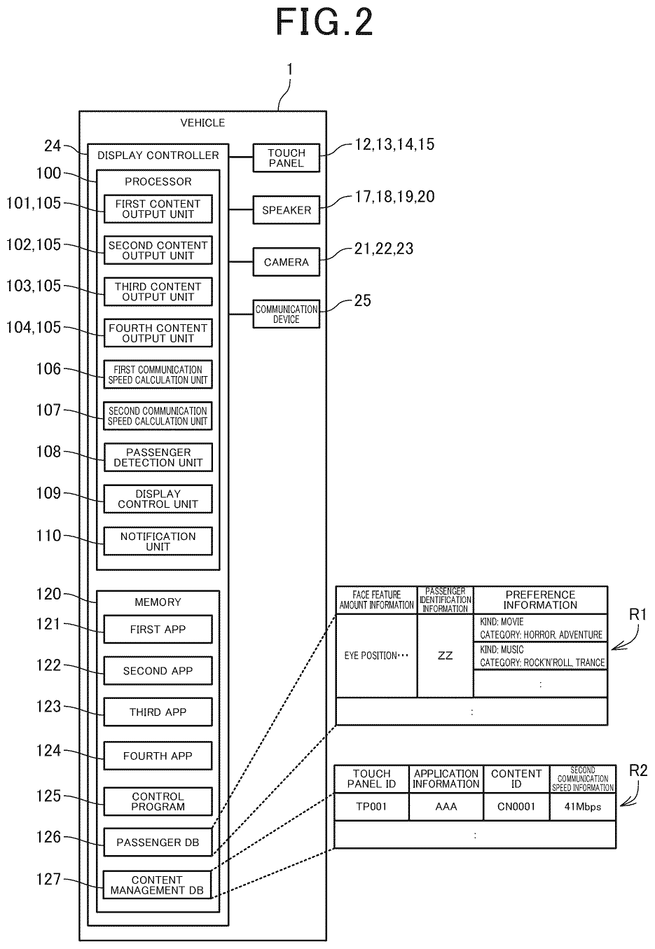

Next, with reference to FIG. 2, the configuration of the display controller 24 will be described.

FIG. 2 is a diagram illustrating the configuration of the display controller 24.

To the display controller 24, the touch panels 12, 13, 14, and 15, the speakers 17, 18, 19, and 20, the cameras 21, 22, and 23, and the communication device 25 are connected. Note that devices connected to the display controller 24 are not limited to these devices and devices of other kinds may be connected further.

The touch panels 12, 13, 14, and 15 display various kinds of information according to control of the display controller 24.

The speakers 17, 18, 19, and 20 output various kinds of sound according to the control of the display controller 24.

The cameras 21, 22, and 23 perform photographing in a predetermined cycle, and output photographed images obtained by photographing to the display controller 24. The communication device 25 communicates with the display controller 24 and the content distribution server 2.

The display controller 24 includes a processor 100 such as a CPU (Central Processing Unit) and an MPU (Micro Processor Unit), a memory 120, and an interface circuit for connecting other devices and sensors.

The memory 120 is an example of a “storage unit”.

The memory 120 is a storage device that stores programs and data. The memory 120 stores a first APP 121, a second APP 122, a third APP 123, a fourth APP 124, a control program 125, a passenger DB (database) 126, a content management DB 127, and data processed by the processor 100. The memory 120 includes a nonvolatile storage area. In addition, the memory 120 may include a volatile storage area and configure a work area of the processor 100. The memory 120 is formed of a ROM (Read Only Memory) and a RAM (Random Access Memory) for example.

The control program 125 is an example of a “program”.

The first APP 121 is an application program for utilizing content distributed by one content distribution source.

The second APP 122 is an application program for utilizing content distributed by a content distribution source different from that of the first APP 121.

The third APP 123 is an application program for utilizing content distributed by a content distribution source different from that of the first APP 121 and the second APP 122.

The fourth APP 124 is an application program for utilizing content distributed by a content distribution source different from that of the first APP 121, the second APP 122, and the third APP 123.

The control program 125 is a program that makes the processor 100 function as functional units to be described later.

The passenger DB 126 is a database having one piece of passenger information R1 for each passenger P. One piece of the passenger information R1 includes face feature amount information, passenger identification information, and one or more pieces of preference information. The passenger information R1 is created in advance and is registered in the passenger DB 126. Note that the passenger information R1 has one piece of preference information for each kind of content preferred by the passenger P. The kind of the content will be described later.

The face feature amount information is information that indicates a face feature amount of the passenger P. The face feature amount indicates a feature amount of a face formed of a plurality of items such as a position of a feature point of an eye, a position of a feature point of a nose, a position of a feature point of a mouth, and a size of a face area.

The passenger identification information is information that identifies the passenger P, and is, for example, information indicating a name, information indicating a given name in a family structure, and information indicating a uniquely allocated number.

The preference information is information that indicates a preference of content of the passenger P. The preference information is information that indicates the kind of content preferred by the passenger P. Further, the preference information is also information that indicates one or more categories of content preferred by the passenger P.

The kinds of content indicate kinds such as movies, moving images, still images, and music.

The category of content is a finer classification than the kind of content. In a case of movies, the categories of content are action movies, adventure movies, animation movies, documentary movies, horror movies, and the like. In the case of music, the categories of content are rock′n′roll, reggae, PHONK, trance, and the like. In the case of moving images, the categories of content are a distribution type, a merchandise introduction type, an entertainment type, a recitation type, and the like. Further, in the case of still images, the categories of content are Western painting, Oriental painting, and the like.

The content management DB 127 is a database having content management information R2 for each of the touch panels 12, 13, 14, and 15. One piece of the content management information R2 includes a touch panel ID, application information, a content ID, and second communication speed information.

The touch panel ID is identification information that identifies the touch panel 26.

The application information is information that indicates the application program for utilizing content displayed by the touch panel 26 of the corresponding touch panel ID. For example, the application information is information that indicates a name of the application program. The application information is appropriately updated by the processor 100 every time the application program for utilizing the content displayed by the touch panel 26 is changed.

The content ID is identification information that identifies the content displayed by the touch panel 26 of the corresponding touch panel ID. The content ID is appropriately updated by the processor 100 every time the content displayed by the touch panel 26 is changed.

The second communication speed information is information that indicates a second communication speed. The second communication speed will be described later. Every time a second communication speed calculation unit 107 described later calculates the second communication speed, the second communication speed indicated by the second communication speed information is appropriately updated to the calculated second communication speed.

The processor 100 functions as a first content output unit 101 by reading and executing the first APP 121 stored in the memory 120.

The first content output unit 101 receives the content of the content distribution source corresponding to the first APP 121 from the content distribution server 2 via the communication device 25. The first content output unit 101 outputs the received content by at least one of the touch panels 12, 13, 14, and 15. Note that, when the content to be output is accompanied by sound, the first content output unit 101 outputs the sound by the speaker 27 corresponding to the touch panel 26 to display the content among the speakers 17, 18, 19, and 20.

The processor 100 functions as a second content output unit 102 by reading and executing the second APP 122 stored in the memory 120.

The second content output unit 102 receives the content of the content distribution source corresponding to the second APP 122 from the content distribution server 2 via the communication device 25. The second content output unit 102 outputs the received content by at least one of the touch panels 12, 13, 14, and 15. Note that, when the content to be output is accompanied by sound, the second content output unit 102 outputs the sound by the speaker 27 corresponding to the touch panel 26 to display the content among the speakers 17, 18, 19, and 20.

The processor 100 functions as a third content output unit 103 by reading and executing the third APP 123 stored in the memory 120.

The third content output unit 103 receives the content of the content distribution source corresponding to the third APP 123 from the content distribution server 2 via the communication device 25. The third content output unit 103 outputs the received content by at least one of the touch panels 12, 13, 14, and 15. Note that, when the content to be output is accompanied by sound, the third content output unit 103 outputs the sound by the speaker 27 corresponding to the touch panel 26 to display the content among the speakers 17, 18, 19, and 20.

The processor 100 functions as a fourth content output unit 104 by reading and executing the fourth APP 124 stored in the memory 120.

The fourth content output unit 104 receives the content of the content distribution source corresponding to the fourth APP 124 from the content distribution server 2 via the communication device 25. The fourth content output unit 104 outputs the received content by at least one of the touch panels 12, 13, 14, and 15. Note that, when the content to be output is accompanied by sound, the fourth content output unit 104 outputs the sound by the speaker 27 corresponding to the touch panel 26 to display the content among the speakers 17, 18, 19, and 20.

Hereinafter, the first content output unit 101, the second content output unit 102, the third content output unit 103, and the fourth content output unit 104 are denoted by a reference numeral “105” and expressed as “content output units 105”, when not to be distinguished from each other.

The content output unit 105 receives content information together with content. The content information includes the content ID, information indicating the kind of the content, and information indicating the category of the content.

The processor 100 functions as a first communication speed calculation unit 106, the second communication speed calculation unit 107, a passenger detection unit 108, a display control unit 109, and a notification unit 110 by reading and executing the control program 125 stored in the memory 120.

### 1-3. First Communication Speed Calculation Unit

The first communication speed calculation unit 106 calculates a first communication speed. The first communication speed is a communication speed between the base station 3 and the communication device 25. The first communication speed calculation unit 106 transmits calculation data for calculating the first communication speed to the base station 3 via the communication device 25, and receives a response to the calculation data from the base station 3. The first communication speed calculation unit 106 calculates the first communication speed by dividing a data amount of the response to the calculation data by the time needed to receive the response to the calculation data.

### 1-4. Second Communication Speed Calculation Unit

The second communication speed calculation unit 107 calculates the second communication speed. The second communication speed is a communication speed required for displaying content by the display controller 24, and is the communication speed in communication between the base station 3 and the display controller 24. The second communication speed calculation unit 107 calculates the second communication speed by calculating a data amount of content received from the base station 3 in a predetermined period and dividing the calculated data amount by the predetermined period.

### 1-5. Passenger Detection Unit

The passenger detection unit 108 detects the passenger P of the vehicle 1.

In the present embodiment, the passenger detection unit 108 detects the passenger P based on the photographed images received from the cameras 21, 22, and 23. The passenger detection unit 108 detects an image of a face by a method of pattern matching or the like for each of the received photographed images. The passenger detection unit 108 detects the passenger P by detecting the image of the face.

When the image of the face is detected, that is, when the passenger P is detected, the passenger detection unit 108 calculates the face feature amount for each detected passenger P. Note that the face feature amount is calculated based on, for example, a size of the image of the face in the photographed image, the position of the feature point of the eye, the position of the feature point of the nose, and the position of the feature point of the mouth in the image of the face, or the like.

### 1-6. Configuration of Display Control Unit

The display control unit 109 controls content displayed by the touch panels 12, 13, 14, and 15. Details of the display control unit 109 will be described when an operation of the display controller 24 is to be described.

### 1-7. Notification Unit

The notification unit 110 gives notification to the passenger P by information display by the touch panels 12, 13, 14, and 15. Notification matters of the notification unit 110 and details of the notification unit 110 will be described when the operation of the display controller 24 is to be described.

### 1-8. Operation of Display Controller

Next, the operation of the display controller 24 will be described.

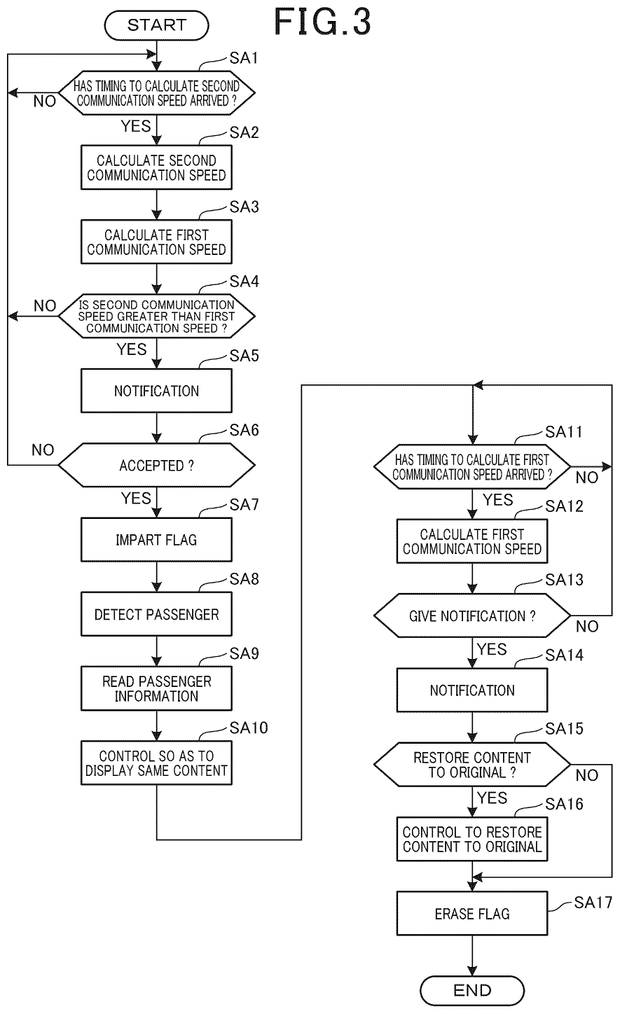

FIG. 3 is a flowchart illustrating the operation of the display controller 24.

The second communication speed calculation unit 107 determines whether or not a timing to calculate the second communication speed has arrived (step SA1). The timing is, for example, when the predetermined period elapses after the second communication speed is previously calculated, or when the predetermined period elapses after content display is started on at least one of the touch panels 12, 13, 14, and 15.

If it is determined that the timing to calculate the second communication speed has not arrived (step SA1: NO), the second communication speed calculation unit 107 makes a determination in step SA1 again.

On the other hand, if it is determined that the timing to calculate the second communication speed has arrived (step SA1: YES), the second communication speed calculation unit 107 calculates the second communication speed (step SA2).

Next, the first communication speed calculation unit 106 calculates the first communication speed (step SA3).

Then, the notification unit 110 determines whether or not the second communication speed calculated in step SA2 is greater than the first communication speed calculated in step SA3 (step SA4).

If it is determined that the second communication speed is not greater than the first communication speed, that is, the second communication speed is equal to or lower than the first communication speed (step SA4: NO), the processor 100 makes the determination in step SA1 again.

If it is determined that the second communication speed is greater than the first communication speed (step SA4: YES), the notification unit 110 gives notification related to the content by one of the touch panels 12, 13, 14, and 15 (step SA5).

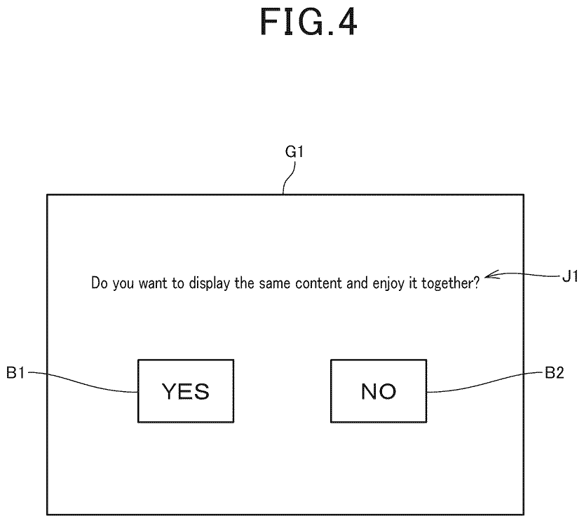

In the present embodiment, the notification unit 110 notifies a matter of proposing the display of the same content as the notification related to the content. For example, the notification unit 110 notifies the matter of proposing the display of the same content by displaying a notification screen G1 illustrated in FIG. 4 on one of the touch panels 12, 13, 14, and 15.

FIG. 4 is a diagram illustrating an example of the notification screen G1.

The notification screen G1 displays notification matter information J1. The notification matter information J1 is information that indicates a notification matter of the notification screen G1, and indicates the matter of proposing the display of the same content. In FIG. 4, a character string of “Do you want to display the same content and enjoy it together?” is the notification matter information J1.

The notification screen G1 displays a YES button B1 and a NO button B2. The YES button B1 is a software button for inputting acceptance of a proposal indicated by the notification matter information J1. The NO button B2 is a software button for inputting refusal of the proposal indicated by the notification matter information J1.

Returning to description of FIG. 3, the display control unit 109 determines whether or not the passenger P has accepted the notification matter notified in step SA5 (step SA6). The display control unit 109 makes an affirmative determination in step SA6 if the YES button B1 is operated on the notification screen G1 displayed by one of the touch panels 12, 13, 14, and 15. The display control unit 109 makes a negative determination in step SA6 if the NO button B2 is operated on the notification screen G1 displayed by one of the touch panels 12, 13, 14, and 15.

If the display control unit 109 makes the negative determination in step SA6 (step SA6: NO), the processor 100 returns processing to step SA1.

On the other hand, if the affirmative determination is made in step SA6 (step SA6: YES), the display control unit 109 imparts a flag to each piece of the content management information R2 that the content management DB 127 has (step SA7). In the content management DB 127 imparted with the flag, information is not updated even when the content displayed by the touch panel 26 is changed or the second communication speed is calculated.

The flag is an example of “predetermined information”.

Next, the passenger detection unit 108 detects the passenger P of the vehicle 1 (step SA8).

Then, the display control unit 109 reads the passenger information R1 corresponding to the detected passenger P from the memory 120 for each passenger P detected in step SA8 (step SA9).

Step SA9 will be described in detail. The display control unit 109 acquires the face feature amount from the passenger detection unit 108 for each passenger P detected in step SA8, and reads the passenger information R1 indicating the face feature amount with a concordance rate with the acquired face feature amount being a threshold or higher from the memory 120 for each passenger P.

Next, the display control unit 109 performs control so that the touch panels 12, 13, 14, and 15 display the same content based on the passenger information R1 read in step SA9 (step SA10).

Step SA10 will be described in detail.

The display control unit 109 refers to the preference information included in each piece of the read passenger information R1, and from pairs of the kind of the preferred content and the category of the preferred content, specifies the most common pair. Then, the display control unit 109 refers to the content information received by the content output unit 105, and selects one piece of content pertinent to the specified pair. Next, the display control unit 109 transmits an instruction to output the selected content on the touch panels 12, 13, 14, and 15 to the content output unit 105 capable of outputting the selected content. Thus, the display control unit 109 performs the control so that the touch panels 12, 13, 14, and 15 display the same content.

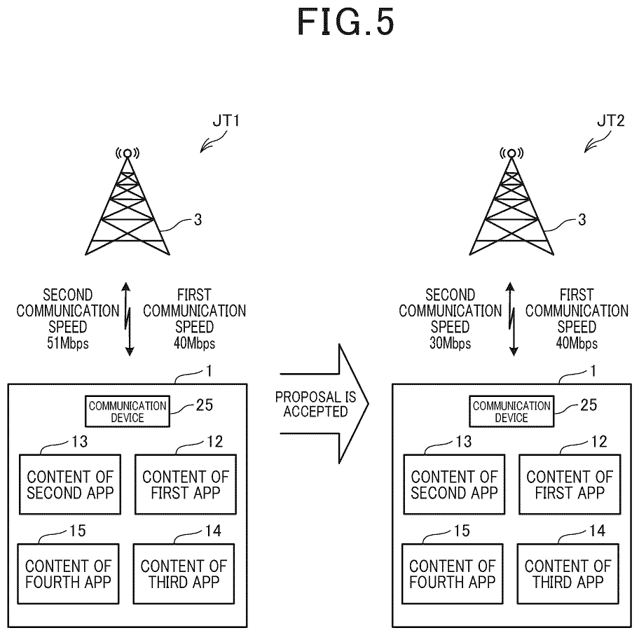

FIG. 5 is a diagram illustrating an example of changeover of the content display.

A state JT1 illustrated in FIG. 5 illustrates a state where the touch panel 12 displays the content distributed by the first APP 121, the touch panel 13 displays the content distributed by the second APP 122, the touch panel 14 displays the content distributed by the third APP 123, and the touch panel 15 displays the content distributed by the fourth APP 124. In addition, the state JT1 illustrated in FIG. 5 illustrates the state where the first communication speed is 40 Mbps, and the second communication speed is 51 Mbps.

In the state JT1 illustrated in FIG. 5, since the second communication speed is greater than the first communication speed, the notification screen G1 is displayed on one of the touch panels 12, 13, 14, and 15. Then, when the YES button B1 is operated on the notification screen G1, the state JT1 illustrated in FIG. 5 is changed to a state JT2 illustrated in FIG. 5.

The state JT2 illustrated in FIG. 5 illustrates a state where the touch panels 12, 13, 14, and 15 display the same content that is the content distributed by the first APP 121. Since the touch panels 12, 13, 14, and 15 display the same content, the communication device 25 only needs to receive one kind of content from the base station 3. Thus, as illustrated in the state JT2 illustrated in FIG. 5, the second communication speed lowers from 51 Mbps to 30 Mbps. Therefore, in the state JT2 in FIG. 5, the second communication speed becomes lower than the first communication speed, and the content is appropriately displayed on the touch panels 12, 13, 14, and 15 without a phenomenon that the content stops or the like.

Returning to the description of the flowchart in FIG. 3, the first communication speed calculation unit 106 determines whether or not a timing to calculate the first communication speed has arrived (step SA11). The timing is, for example, when the predetermined period elapses after the first communication speed is previously calculated, or when the predetermined period elapses after the touch panels 12, 13, 14, and 15 start the display of the same content.

If it is determined that the timing to calculate the first communication speed has not arrived (step SA11: NO), the first communication speed calculation unit 106 makes a determination in step SA11 again.

On the other hand, if it is determined that the timing to calculate the first communication speed has arrived (step SA11: YES), the first communication speed calculation unit 106 calculates the first communication speed (step SA12).

Next, the notification unit 110 determines whether or not to give notification for inquiring whether or not to restore the content to be displayed to an original based on the first communication speed calculated in step SA12 (step SA13).

Step SA13 will be described in detail.

The notification unit 110 makes an affirmative determination in step SA13 if the first communication speed becomes greater than the second communication speed indicated by the second communication speed information of the content management information R2 imparted with the flag.

In more detail with a specific example, the notification unit 110 gives the affirmative determination in step SA13 if the first communication speed becomes greater than the second communication speed indicated by the second communication speed information of the content management information R2 imparted with the flag by a predetermined value (for example, 10 Mbps) or more.

In more detail with another specific example, the notification unit 110 gives the affirmative determination in step SA13 if the first communication speed becomes greater than the second communication speed indicated by the second communication speed information of the content management information R2 imparted with the flag continuously for a predetermined period or longer.

If the notification unit 110 determines not to give the notification for inquiring whether or not to restore the content to be displayed to the original (step SA13: NO), the processor 100 returns the processing to step SA11.

On the other hand, if it is determined to give the notification for inquiring whether or not to restore the content to be displayed to the original (step SA13: YES), the notification unit 110 gives the notification (step SA14).

Step SA14 will be described in detail.

In step SA14, the notification unit 110 displays a notification screen G2 by one of the touch panels 12, 13, 14, and 15.

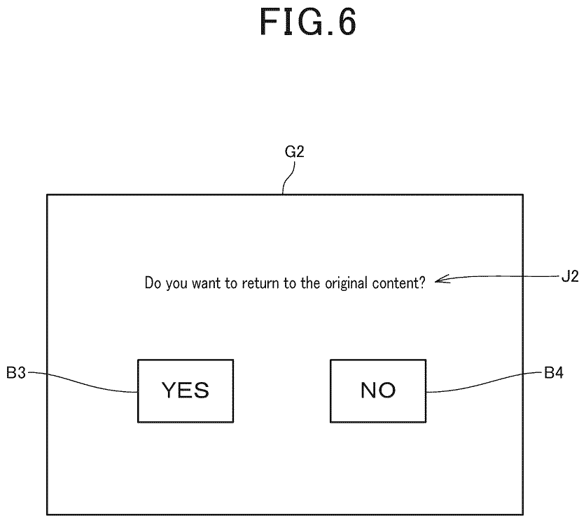

FIG. 6 is a diagram illustrating an example of the notification screen G2.

The notification screen G2 displays inquiry information J2. The inquiry information J2 is information indicating the notification matter of the notification screen G2, and indicates an inquiry about whether or not to restore the content to the original. In FIG. 6, a character string of “Do you want to return to the original content?” is the inquiry information J2.

The notification screen G2 displays a YES button B3 and a NO button B4. The YES button B3 is a software button for inputting that the content is to be restored to the original. The NO button B4 is a software button for inputting that the content is not to be restored to the original.

Returning to the description of the flowchart in FIG. 3, the display control unit 109 determines whether or not to restore the content to be displayed to the original (step SA15). The display control unit 109 makes an affirmative determination in step SA15 if the YES button B3 is operated on the notification screen G2 displayed by one of the touch panels 12, 13, 14, and 15. The display control unit 109 makes a negative determination in step SA15 if the NO button B4 is operated on the notification screen G2 displayed by one of the touch panels 12, 13, 14, and 15.

If the display control unit 109 determines not to restore the content to be displayed to the original (step SA15: NO), the processor 100 ends the present processing.

On the other hand, if the display control unit 109 determines to restore the content to be displayed to the original (step SA15: YES), control to restore the content to be displayed by the touch panels 12, 13, 14, and 15 to the original is performed (step SA16).

Step SA16 will be described in detail.

The display control unit 109 performs following processing for each content management information R2.

That is, the display control unit 109 transmits an instruction to output the content indicated by the content ID on the touch panel 26 indicated by the touch panel ID to the content output unit 105 corresponding to the application program indicated by the application information.

Then, the display control unit 109 erases the flag from the content management information R2 (step SA17).

### 2. Second Embodiment

Next, the second embodiment will be described.

In the description of the second embodiment, differences from the first embodiment will be mainly described.

The first embodiment is configured to inquire whether or not to restore the content to be displayed to the original after the same content is displayed.

In the second embodiment, after the same content is displayed, the content to be displayed is restored to the original without inquiring whether or not to restore the content to be displayed to the original if a first condition below is established.

The first condition is that the first communication speed is greater than the second communication speed indicated by the second communication speed information of the content management information R2 imparted with the flag and the displayed same content is in a predetermined situation. Here, the predetermined situation indicates a situation where output of the content is to end, indicates a situation where a video image or a moving image is to end when the content is the video image or the moving image, and indicates a situation where one piece of music is to end when the content is the music.

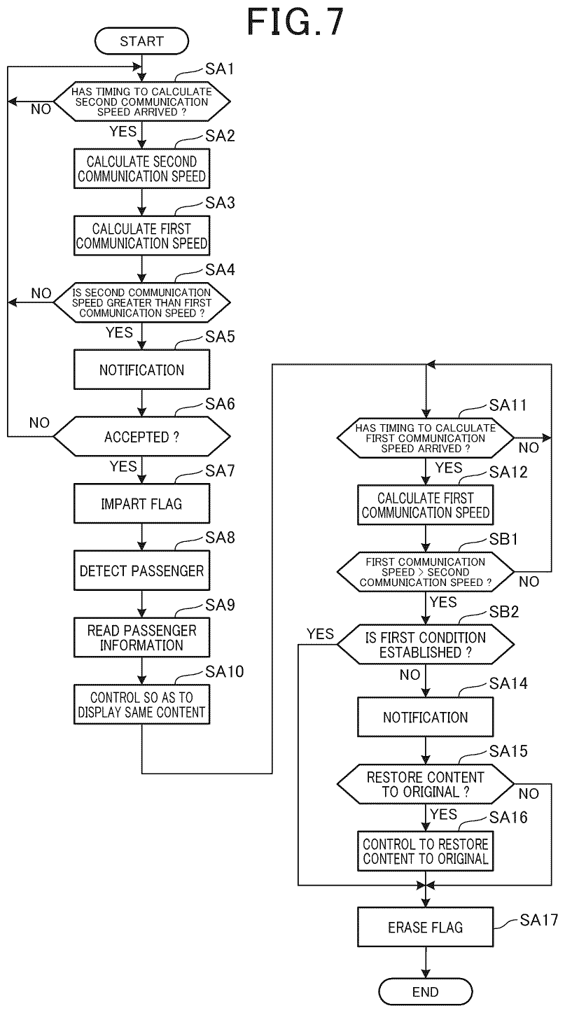

FIG. 7 is a flowchart illustrating the operation of the display controller 24.

In FIG. 7, steps similar to that in FIG. 3 are denoted by same reference signs. Then, in the description of FIG. 7, the detailed description of the steps similar to that in FIG. 3 is appropriately omitted.

The notification unit 110 determines whether or not the first communication speed is greater than the second communication speed indicated by the second communication speed information of the content management information R2 imparted with the flag, based on the first communication speed calculated in step SA12 (step SB1).

If the notification unit 110 determines that the first communication speed is not greater than the second communication speed, in other words, the second communication speed is equal to or greater than the first communication speed (step SB1: NO), the processor 100 returns the processing to step SA11.

On the other hand, if it is determined that the first communication speed is greater than the second communication speed (step SB1: YES), the notification unit 110 determines whether or not the first condition is established (step SB2). The notification unit 110 acquires the remaining time until the end of the content from the content output unit 105 displaying the same content by the touch panels 12, 13, 14, and 15. Then, the notification unit 110 determines that the content is in a predetermined state and gives an affirmative determination in step SB2 if the acquired remaining time is equal to or shorter than a predetermined time (one minute, for example), and determines that the content is not in the predetermined state and gives a negative determination in step SB2 if the acquired remaining time is longer than the predetermined time (one minute, for example).

If the notification unit 110 determines that the first condition is not established (step SB2: NO), the processor 100 executes the processing of step SA14 and thereafter.

On the other hand, if the notification unit 110 determines that the first condition is established (step SB2: YES), the processor 100 skips steps SA14 and SA15, and executes the processing of step SA16.

### 3. Third Embodiment

Next, the third embodiment will be described.

In the description of the third embodiment, differences from the first embodiment will be mainly described.

In the description of the third embodiment, components same as the components of the first embodiment are denoted by the same reference signs and the detailed description is appropriately omitted.

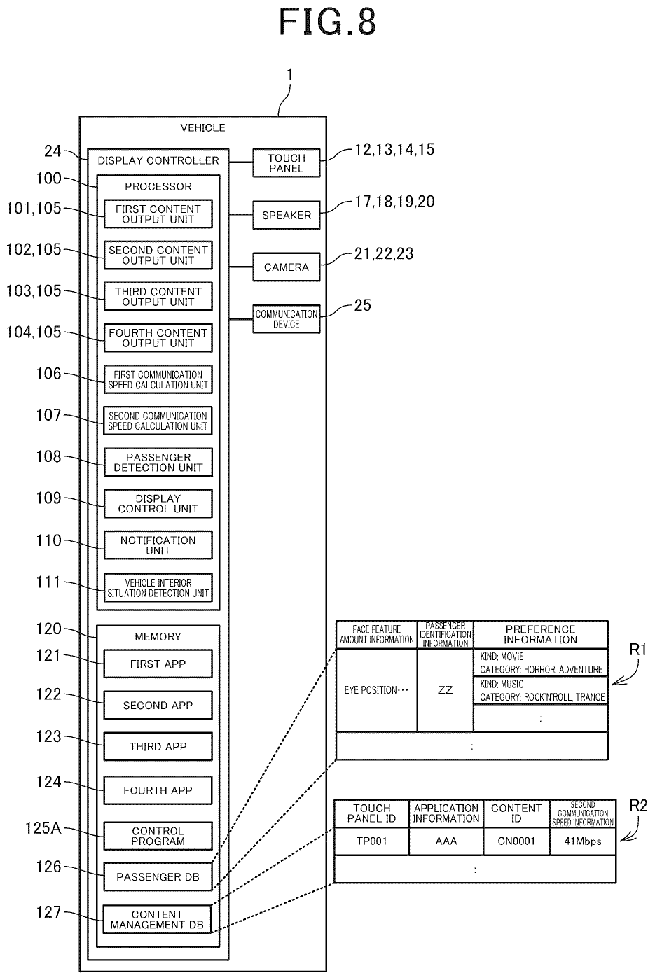

FIG. 8 is a diagram illustrating the configuration of the display controller 24 according to the third embodiment.

As is clear from a comparison between FIG. 8 and FIG. 2, the memory 120 stores a control program 125A instead of the control program 125.

The control program 125A is a program that makes the processor 100 function further as a vehicle interior situation detection unit 111.

The vehicle interior situation detection unit 111 detects whether the situation inside the vehicle 1 is a predetermined situation. Here, the predetermined situation is a situation where the passenger P of the vehicle 1 is not watching the content, a situation where the passenger P of the vehicle 1 is not excited with the output content, and the like.

The vehicle interior situation detection unit 111 detects a state of the passenger P in a predetermined cycle for each passenger P detected by the passenger detection unit 108. In the present embodiment, the vehicle interior situation detection unit 111 detects whether or not the state of the passenger P is a state of not looking at the touch panel and whether or not it is the state of not intensively watching the content. The vehicle interior situation detection unit 111 detects a line of sight of the passenger P and an eye state of the passenger P in the predetermined cycle by technology of pattern matching or the like from the photographed images of the cameras 21, 22, and 23. Then, the vehicle interior situation detection unit 111 detects that the it is the state of not looking at the touch panel 26 when the line of sight of the passenger P is not in a direction of the touch panel 26 for a predetermined period or longer or when the eye state of the passenger P is a closed state for the predetermined period or longer. Further, the vehicle interior situation detection unit 111 detects that the state of the passenger P is the state of not intensively watching the content when the line of sight of the passenger P deviates from the direction of the touch panel 26 during the predetermined period.

For the photographed image of the camera 21, since the directions of the touch panels 12 and 13 are determined, the vehicle interior situation detection unit 111 can detect whether or not the directions of the line of sight of the passengers P in the driver's seat 10A and the front passenger seat 10B and the directions of the touch panels 12 and 13 coincide.

In addition, for the photographed image of the camera 22, since the direction of the touch panel 14 is determined, the vehicle interior situation detection unit 111 can detect whether or not the direction of the line of sight of the passenger P in the rear right seat 10C and the direction of the touch panel 14 coincide.

Further, for the photographed image of the camera 23, since the direction of the touch panel 15 is determined, the vehicle interior situation detection unit 111 can detect whether or not the direction of the line of sight of the passenger P in the rear left seat 10D and the direction of the touch panel 15 coincide.

In the case of detecting either the state of not looking at the touch panel or the state of not intensively watching the content for at least more than half the passengers P detected by the passenger detection unit 108, the vehicle interior situation detection unit 111 detects that the situation of the vehicle 1 is the predetermined situation.

Next, the operation of the display controller 24 in the third embodiment will be described.

The first embodiment is configured to give notification for inquiring whether or not to restore the content to be displayed to the original after the same content is displayed.

In the third embodiment, after the same content is displayed, the content to be displayed is restored to the original without giving the notification for inquiring whether or not to restore the content to be displayed to the original if a second condition below is established.

The second condition is that the first communication speed is greater than the second communication speed indicated by the second communication speed information of the content management information R2 imparted with the flag and the vehicle interior situation is the predetermined situation.

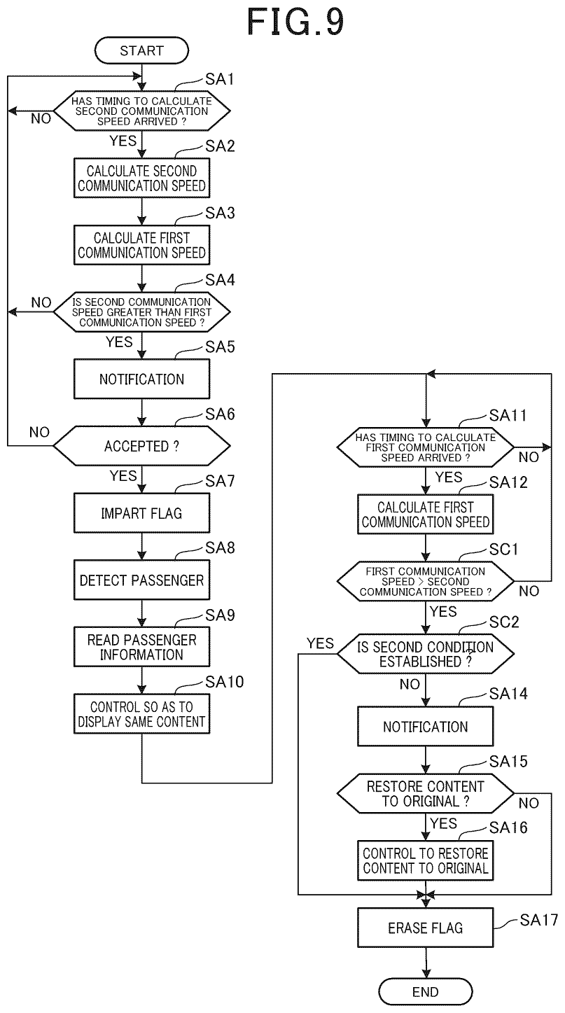

FIG. 9 is a flowchart illustrating the operation of the display controller 24.

In FIG. 9, steps similar to that in FIG. 3 are denoted by same reference signs. Then, in the description of FIG. 9, the detailed description of the steps similar to that in FIG. 3 is appropriately omitted.

The notification unit 110 determines whether or not the first communication speed is greater than the second communication speed indicated by the second communication speed information of the content management information R2 imparted with the flag, based on the first communication speed calculated in step SA12 (step SC1).

If the notification unit 110 determines that the first communication speed is not greater than the second communication speed, in other words, the second communication speed is equal to or greater than the first communication speed (step SC1: NO), the processor 100 returns the processing to step SA11.

On the other hand, if it is determined that the first communication speed is greater than the second communication speed (step SC1: YES), the notification unit 110 determines whether or not the second condition is established (step SC2). The notification unit 110 acquires a detection result from the vehicle interior situation detection unit 111, gives an affirmative determination in step SC2 if the acquired detection result indicates the predetermined situation, and gives a negative determination in step SC2 if the acquired detection result does not indicate the predetermined situation.

If the notification unit 110 determines that the second condition is not established (step SC2: NO), the processor 100 executes the processing of step SA14 and thereafter.

On the other hand, if the notification unit 110 determines that the second condition is established (step SC2: YES), the processor 100 skips steps SA14 and SA15, and executes the processing of step SA16.

### 4. Fourth Embodiment

Next, the fourth embodiment will be described.

In the description of the fourth embodiment, differences from the embodiments described above will be mainly described.

In the embodiments described above, when the second communication speed becomes greater than the first communication speed, a proposal to display the same content is presented, and when the passenger P accepts the proposal, the touch panels 12, 13, 14, and 15 display the same content.

In the fourth embodiment, when the second communication speed becomes greater than the first communication speed, a proposal to control image quality of the content is presented, and when the passenger P accepts the proposal, the image quality of the content displayed by at least one of the touch panels 12, 13, 14, and 15 is controlled.

When the second communication speed exceeds the first communication speed, the notification unit 110 notifies a matter of proposing control of the image quality of the content. In more details, the notification unit 110 notifies the matter of proposing the control of the image quality of the content by displaying a notification screen like the notification screens G1 and G2 on one of the touch panels 12, 13, 14, and 15.

If the passenger P accepts the notification matter of the notification unit 110, the display control unit 109 controls the image quality of the content so that the second communication speed becomes lower than the first communication speed, and determines the touch panel 26 to control the image quality so that the number of the touch panels 26 to control the image quality is as small as possible.

For example, the display control unit 109 instructs the content output unit 105 that outputs the content displayed by a certain touch panel 26 to receive the content of the image quality lower than the image quality at present, and instructs the first communication speed calculation unit 106 and the second communication speed calculation unit 107 to calculate the communication speed. The display control unit 109 ends the control of the image quality when the calculated second communication speed is equal to or lower than the calculated first communication speed, adds one touch panel 26 to control the image quality further when the calculated second communication speed is greater than the calculated first communication speed, instructs reception of the content of the low image quality, instructs calculation of the communication speed, and repeats the above processing.

### 5. Other Embodiments

The embodiments described above merely indicate one aspect and arbitrary modifications and applications are possible.

In the embodiments described above, the display controller 24 provided in the vehicle 1 is exemplified as the “display controller”. However, the “display controller” is not limited to the device provided in the vehicle 1. The “display controller” may be a terminal device such as a smartphone or a tablet terminal. In this case, the “display controller” receives content from a router and makes a plurality of other communication-connected terminal devices display the content. In this case, the router corresponds to the “outside”. Further, the “display controller” may be a router provided in a facility such as a house. In this case, the router makes the content received from the outside be displayed by a communication-connected display. In the case of this other embodiment, the “display controller” is provided with a “communication device”.

While the notification unit 110 gives various kinds of notifications by display in the embodiments described above, the notification unit 110 may give the various kinds of notification by voice output.

In the embodiments described above, the passenger P performs input by a touch operation for the notification given by the notification unit 110. In another embodiment, a microphone may be provided in the vehicle 1 and the passenger P can perform various kinds of input for the notification given by the notification unit 110 by voice.

While the notification unit 110 gives the notification by one touch panel 26 in the embodiments described above, the notification unit 110 may give the notification by the plurality of touch panels 26.

In the embodiments described above, the same content is displayed on all the touch panels 26. In another embodiment, the same content may be displayed on at least two or more touch panels 26.

While a flag is attached to the content management information R2 in the embodiments described above, the “predetermined information” attached to the content management information R2 is not limited to the flag.

In the embodiments described above, when the second communication speed exceeds the first communication speed, the notification unit 110 executes the notification of the matter of proposing the display of the same content as the notification related to the content. However, the notification related to the content given by the notification unit 110 is not limited to the notification of the matter of the proposal, and may be, for example, a proposal of appropriately displaying the content or a proposal of improving the communication speed.

In the embodiments described above, the case of a 4-seater vehicle 1 is exemplified. However, a passenger capacity of the vehicle 1 is not limited to four.

While a four-wheel vehicle 1 is exemplified in the embodiments described above, the number of wheels of the vehicle 1 is not limited to four.

While the touch panel 26 is exemplified as the “display unit” in the embodiments described above, the “display unit” is not limited to a display having a touch operation function, and may be a display that is operable with an operation key or the like without having the touch operation function.

While the display controller 24 is not provided with the “display unit” in the embodiments described above, the display controller 24 may be provided with the “display unit”.

In the embodiments described above, the passenger P is detected from the photographed images of the cameras 21, 22, and 23. In another embodiment, the passenger detection unit 108 may detect the passenger P by a method other than the photographed images of the cameras 21, 22, and 23. For example, when who is to get on is input to the display controller 24 at the time of getting on, the passenger detection unit 108 may detect the passenger P by the input. Further, in another embodiment, when a microphone that collects voice of the passenger P is provided in the vehicle 1, the passenger detection unit 108 may detect the passenger P based on the number of pieces and kinds of the voice collected by the microphone.

In the embodiments described above, the four application programs for utilizing the content are installed in the display controller 24. In another embodiment, three or fewer or five or more application programs may be installed in the display controller 24.

The processor 100 may be formed of a plurality of processors, or may be formed of one processor. The processor 100 may be hardware programmed to realize the functional units described above. In this case, the processors are formed of an ASIC (Application Specific Integrated Circuit) and an FPGA (Field Programmable Gate Array), for example.

Further, the configuration of the units of the display controller 24 illustrated in FIG. 2 and FIG. 8 and the configuration of the units of the vehicle 1 illustrated in FIG. 1 are only examples, and a specific mounting form is not limited in particular. That is, hardware individually corresponding to each unit does not need to be mounted, and it is also possible that one processor realizes functions of the respective units by executing a program. In addition, some of the functions realized by software in the embodiments described above may be hardware, or some of the functions realized by hardware may be realized by software.

Step units of the operation illustrated in FIG. 3, FIG. 7, and FIG. 9 are divided according to main processing contents, and the present invention is not limited by a dividing method or a name of a processing unit. Division into further more step units may be performed according to the processing contents. Division may be also performed such that one step unit includes further more processing. Furthermore, the order of steps may be appropriately changed without interfering with the gist of the present invention.

Further, when a method of controlling the display controller 24 described above is realized using the processor 100, the program to be executed by the processor 100 can be configured in a form of a recording medium or a transmission medium that transmits the program. That is, the control program 125 can be realized in a state of recording the control program 125 in a portable information recording medium. While examples of the information recording medium include a magnetic recording medium such as a hard disk, an optical recording medium such as a CD, and a semiconductor storage device such as a USB (Universal Serial Bus) memory and an SSD (Solid State Drive), other recording media can also be used.

### 6. Configurations Supported by Embodiments Described Above

The embodiments described above support the following configurations.

### (Configuration 1)

A display controller that displays content received by a communication device from outside by a plurality of display units, the display controller including a notification unit configured to give notification related to the content to be displayed by the display units based on a first communication speed between the communication device and the outside and a second communication speed between the communication device and the outside required for displaying the content.

According to the display controller of configuration 1, since the notification related to the content can be given according to a communication situation between the outside and the communication device, a user of the content can act such that the content is appropriately displayed according to the communication situation related to the content.

### (Configuration 2)

The display controller according to configuration 1, including a display control unit configured to control the content displayed by the plurality of display units, wherein a notification matter of the notification unit is a matter of proposing display of the same content, and the display control unit performs control so that at least two or more of the plurality of display units display the same content when a user of the display units accepts the notification matter of the notification unit.

According to the display controller of configuration 2, by performing the control to display the same content on at least two or more display units, the number of pieces of the content received by the communication device can be reduced. Thus, a communication amount between the outside and the communication device can be reduced, occurrence of a phenomenon that the content cannot be displayed or the like can be suppressed, and the content can be appropriately displayed.

### (Configuration 3)

The display controller according to configuration 2, the display controller being provided in a vehicle, and including: a passenger detection unit configured to detect a passenger of the vehicle; and a storage unit configured to store passenger information regarding the passenger of the vehicle, wherein the display control unit, when the user of the display units accepts the notification matter of the notification unit, acquires the passenger information corresponding to the passenger of the vehicle detected by the passenger detection unit from the storage unit, and performs control so that at least two or more of the plurality of display units display the same content based on the acquired passenger information.

According to the display controller of configuration 3, since the content based on the passenger information corresponding to the passenger of the vehicle can be displayed, a possibility of displaying the content suited to the passenger can be increased.

### (Configuration 4)

The display controller according to configuration 1, including a display control unit configured to control the content displayed by the plurality of display units, wherein a notification matter of the notification unit is a matter of proposing control of image quality of the content, and the display control unit, when a user of the display units accepts a proposal indicated by the notification matter of the notification unit, controls the image quality of the content so that the second communication speed becomes lower than the first communication speed, and determines the display unit to control the image quality of the content so that the number of the display units to control the image quality of the content is as small as possible.

According to the display controller of configuration 4, the communication amount between the outside and the communication device can be reduced, and the number of pieces of the content to control the image quality can be minimized. Thus, the content can be appropriately displayed while minimizing the number of users who feel uncomfortable with the display of the content.

### (Configuration 5)

The display controller according to configuration 2 or configuration 3, including a storage unit configured to store identification information that identifies the content displayed by the display unit before the notification of the notification unit and second communication speed information indicating the second communication speed in correspondence, wherein the display control unit imparts predetermined information to the second communication speed information stored by the storage unit when the user of the display units accepts a proposal indicated by the notification matter of the notification unit, and the notification unit gives notification for inquiring whether or not to restore the content to be displayed to the content before display of the same content, when the first communication speed becomes greater than the second communication speed indicated by the second communication speed information imparted with the predetermined information after the same content is displayed.

According to the display controller of configuration 5, since whether or not to restore the content to be displayed to the original is inquired when the first communication speed becomes greater than the second communication speed, the user can perform an action of returning to desired content at an appropriate timing after the display of the same content.

### (Configuration 6)

The display controller according to configuration 5, wherein, when the first communication speed becomes greater than the second communication speed indicated by the second communication speed information imparted with the predetermined information after the same content is displayed and the same content displayed by at least two or more of the display units is in a predetermined situation, the notification unit does not give the notification for inquiring whether or not to restore the content to be displayed to the content before the display of the same content, and the display control unit makes the display unit that has been displaying the same content display the content indicated by the identification information imparted with the predetermined information.

According to the display controller of configuration 6, when the displayed same content is in the predetermined situation, the content displayed before the display of the same content can be automatically restored. Therefore, the control can be performed so as to display the content desired by the user at an appropriate timing without taking up the time and labor of the user.

### (Configuration 7)

The display controller according to configuration 5, the display controller being provided in a vehicle, and including a vehicle interior situation detection unit configured to detect an interior situation of the vehicle, wherein, when the first communication speed becomes greater than the second communication speed indicated by the second communication speed information imparted with the predetermined information after the same content is displayed and the vehicle interior situation detected by the vehicle interior situation detection unit is a predetermined situation, the notification unit does not give the notification for inquiring whether or not to restore the content to be displayed to the content before the display of the same content, and the display control unit makes the display unit that has been displaying the same content display the content indicated by the identification information imparted with the predetermined information.

According to the display controller of configuration 7, when the vehicle interior situation is the predetermined situation, the content displayed before the display of the same content can be automatically restored. Therefore, the control can be performed so as to display the content desired by the user at the appropriate timing without taking up the time and labor of the user.

### (Configuration 8)

The display controller according to configuration 5, wherein, when the first communication speed is greater than the second communication speed indicated by the second communication speed information imparted with the predetermined information continuously for a predetermined period or longer after the same content is displayed, the notification unit gives notification for inquiring whether or not to restore the content to be displayed to the content before the display of the same content.

According to the display controller of configuration 8, since the notification can be suppressed from being given every time the first communication speed becomes greater than the second communication speed, it is possible to suppress the user from feeling troublesome with the notification.

### (Configuration 9)

The display controller according to configuration 5, wherein, when the first communication speed becomes greater than the second communication speed indicated by the second communication speed information imparted with the predetermined information by a predetermined value or more after the same content is displayed, the notification unit gives notification for inquiring whether or not to restore the content to be displayed to the content before the display of the same content.

According to the display controller of configuration 9, since the notification can be suppressed from being given every time the first communication speed becomes greater than the second communication speed, it is possible to suppress the user from feeling troublesome with the notification.

### (Configuration 10)

A method of controlling a display controller that displays content received by a communication device from outside by a plurality of display units, wherein notification related to the content to be displayed by the display units is given based on a first communication speed between the communication device and the outside and a second communication speed between the communication device and the outside required for displaying the content.

According to the method of controlling the display controller of configuration 10, an effect similar to that of the display controller of configuration 1 is accomplished.

### (Configuration 11)

A non-transitory computer-readable storage medium storing a program that makes a processor of a display controller that displays content received by a communication device from outside by a plurality of display units function as a notification unit configured to give notification related to the content to be displayed by the display units based on a first communication speed between the communication device and the outside and a second communication speed between the communication device and the outside required for displaying the content.

According to the program of configuration 11, the effect similar to that of the display controller of configuration 1 is accomplished.

### REFERENCE SIGNS LIST

1 . . . vehicle, 2 . . . content distribution server, 3 . . . base station (outside), 10A . . . driver's seat, 10B . . . front passenger seat, 10C . . . rear right seat, 10D . . . rear left seat, 11A . . . right front door, 11B . . . left front door, 11C . . . right rear door, 11D . . . left rear door, 11E . . . tailgate, 12, 13, 14, 15, 26 . . . touch panel (display unit), 16 . . . dashboard, 17, 18, 19, 20, 27 . . . speaker, 21, 22, 23 . . . camera, 24 . . . display controller, 25 . . . . communication device, 100 . . . processor, 101 . . . first content output unit, 102 . . . second content output unit, 103 . . . third content output unit, 104 . . . fourth content output unit, 105 . . . content output unit, 106 . . . first communication speed calculation unit, 107 . . . second communication speed calculation unit, 108 . . . passenger detection unit, 109 . . . display control unit, 110 . . . notification unit, 111 . . . vehicle interior situation detection unit, 120 . . . memory (storage unit), 121 . . . first APP, 122 . . . second APP, 123 . . . third APP, 124 . . . fourth APP, 125, 125A. . . . control program (program), 126 . . . passenger DB, 127 . . . content management DB, 1000 . . . content distribution system, G1, G2 . . . notification screen, J1 . . . notification matter information, J2 . . . inquiry information, JT1, JT2 . . . state, NW . . . network, P, P1, P2, P3, P4 . . . passenger (user), R1 . . . passenger information, R2 . . . content management information.

1. A display controller that displays content received by a communication device from outside by a plurality of display units, the display controller comprising:
a notification unit configured to give notification related to the content to be displayed by the display units based on a first communication speed between the communication device and the outside and a second communication speed between the communication device and the outside required for displaying the content.

2. The display controller according to claim 1, comprising:
a display control unit configured to control the content displayed by the plurality of display units,
wherein a notification matter of the notification unit is a matter of proposing display of the same content, and
the display control unit
performs control so that at least two or more of the plurality of display units display the same content when a user of the display units accepts the notification matter of the notification unit.

3. The display controller according to claim 2,
the display controller being provided in a vehicle, and comprising:
a passenger detection unit configured to detect a passenger of the vehicle; and
a storage unit configured to store passenger information regarding the passenger of the vehicle,
wherein the display control unit,
when the user of the display units accepts the notification matter of the notification unit,
acquires the passenger information corresponding to the passenger of the vehicle detected by the passenger detection unit from the storage unit, and
performs control so that at least two or more of the plurality of display units display the same content based on the acquired passenger information.

4. The display controller according to claim 1, comprising:
a display control unit configured to control the content displayed by the plurality of display units,
wherein a notification matter of the notification unit is a matter of proposing control of image quality of the content, and
the display control unit,
when a user of the display units accepts a proposal indicated by the notification matter of the notification unit,
controls the image quality of the content so that the second communication speed becomes lower than the first communication speed, and
determines the display unit to control the image quality of the content so that the number of the display units to control the image quality of the content is as small as possible.

5. The display controller according to claim 2, comprising:
a storage unit configured to store identification information that identifies the content displayed by the display unit before the notification of the notification unit and second communication speed information indicating the second communication speed in correspondence,
wherein the display control unit
imparts predetermined information to the second communication speed information stored by the storage unit when the user of the display units accepts a proposal indicated by the notification matter of the notification unit, and
the notification unit
gives notification for inquiring whether or not to restore the content to be displayed to the content before display of the same content, when the first communication speed becomes greater than the second communication speed indicated by the second communication speed information imparted with the predetermined information after the same content is displayed.

6. The display controller according to claim 5,
wherein, when the first communication speed becomes greater than the second communication speed indicated by the second communication speed information imparted with the predetermined information after the same content is displayed and the same content displayed by at least two or more of the display units is in a predetermined situation,
the notification unit does not give the notification for inquiring whether or not to restore the content to be displayed to the content before the display of the same content, and
the display control unit makes the display unit that has been displaying the same content display the content indicated by the identification information imparted with the predetermined information.

7. The display controller according to claim 5,
the display controller being provided in a vehicle, and comprising:
a vehicle interior situation detection unit configured to detect an interior situation of the vehicle,
wherein, when the first communication speed becomes greater than the second communication speed indicated by the second communication speed information imparted with the predetermined information after the same content is displayed and the vehicle interior situation detected by the vehicle interior situation detection unit is a predetermined situation,
the notification unit does not give the notification for inquiring whether or not to restore the content to be displayed to the content before the display of the same content, and
the display control unit makes the display unit that has been displaying the same content display the content indicated by the identification information imparted with the predetermined information.

8. The display controller according to claim 5,
wherein, when the first communication speed is greater than the second communication speed indicated by the second communication speed information imparted with the predetermined information continuously for a predetermined period or longer after the same content is displayed,
the notification unit gives notification for inquiring whether or not to restore the content to be displayed to the content before the display of the same content.

9. The display controller according to claim 5,
wherein, when the first communication speed becomes greater than the second communication speed indicated by the second communication speed information imparted with the predetermined information by a predetermined value or more after the same content is displayed,
the notification unit gives notification for inquiring whether or not to restore the content to be displayed to the content before the display of the same content.

10. A method of controlling a display controller that displays content received by a communication device from outside by a plurality of display units,
wherein notification related to the content to be displayed by the display units is given based on a first communication speed between the communication device and the outside and a second communication speed between the communication device and the outside required for displaying the content.

11. A non-transitory computer-readable storage medium storing a program that makes
a processor of a display controller that displays content received by a communication device from outside by a plurality of display units
function as a notification unit configured to give notification related to the content to be displayed by the display units based on a first communication speed between the communication device and the outside and a second communication speed between the communication device and the outside required for displaying the content.
